(19) United States
(12) Patent Application Publication
(10) Pub. No.: US 2025/0042297 A1
(43) Pub. Date: Feb. 6, 2025

(54) BATTERY SYSTEM OF VEHICLE USING SWAPPABLE AUXILIARY BATTERY, AND CONTROL METHOD THEREOF

(71) Applicants: Hyundai Motor Company, Seoul (KR); Kia Corporation, Seoul (KR)

(72) Inventor: Un CHON, Seongnam-si (KR)

(73) Assignees: Hyundai Motor Company, Seoul (KR); Kia Corporation, Seoul (KR)

(21) Appl. No.: 18/396,915

(22) Filed: Dec. 27, 2023

(30) Foreign Application Priority Data
Aug. 3, 2023 (KR) 10-2023-0101495

(51) Int. Cl. B60L 58/22; B60L 58/20; H02J 7/00; H02J 7/34

(52) U.S. Cl. CPC B60L 58/22; B60L 58/20; H02J 7/00712; H02J 7/342; H02J 2207/20

(57) ABSTRACT

A battery system of a vehicle using a swappable auxiliary battery and a control method thereof includes a main battery configured to be selectively connected to a load of the vehicle using a first switch, a battery slot providing a space into which an auxiliary battery is inserted and be connected to the load of the vehicle using a second switch, and a controller configured to turn off the first switch and turn on the second switch in response to the auxiliary battery being inserted into the battery slot.

### CROSS REFERENCE TO RELATED APPLICATION

The present application claims priority to Korean Patent Application No. 10-2023-0101495, filed Aug. 3, 2023, the entire contents of which is incorporated herein for all purposes by this reference.

### BACKGROUND OF THE INVENTION

### Field of the Invention

The present disclosure relates to a battery system of a vehicle, and more particularly, a battery system of a vehicle using swappable auxiliary battery and a control method thereof.

### Description of Related Art

The content described below merely provides background information related to the present embodiment and does not constitute the related art.

Generally, eco-friendly vehicles (hybrid vehicles, electric vehicles, fuel cell vehicles, etc.) equipped with an electric motor to provide driving force of wheels include a high-voltage battery to provide high-voltage energy for driving the electric motor.

The price of the high-voltage battery greatly affects cost competitiveness of the eco-friendly vehicles, and in order to minimize the price of the high-voltage battery, techniques are developed in a direction reducing capacity and lowering voltage. However, such a reduction in the capacity of the high-voltage battery has a problem of reducing the driving distance of the vehicle and lowering the output power of the motor/inverter.

As a method for solving the present problem, a method of arranging one or a plurality of swappable auxiliary batteries inside the vehicle and charging the main battery using one or a plurality of swappable batteries is provided.

Although the main battery and the auxiliary batteries may have the same maximum voltage, they have a flexible voltage range according to the status of charge (SOC) of the battery.

Conventionally, a method of preferentially using the main battery over the auxiliary batteries or a method of simultaneously using the batteries is used. In the present case, as the main battery is used although the auxiliary batteries are swappable, there is a problem in that the lifespan of the main battery rapidly decreases due to repetitive charging and discharging of the main battery.

Furthermore, when the main battery and the auxiliary batteries are connected in a simple short-circuit structure, there is a risk of fire and burnout of parts due to a voltage difference.

Furthermore, since an auxiliary battery is swapped with a new auxiliary battery even when energy remains in the auxiliary battery in the related art, there is a problem in that power of the auxiliary batteries is not fully utilized.

Therefore, research on battery systems for solving the above problems is required.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present disclosure are directed to providing a battery system of a vehicle. The battery system comprises a main battery configured to be selectively connected to a load of the vehicle using a first switch, a battery slot providing a space into which an auxiliary battery is inserted and be connected to the load of the vehicle using a second switch, and a controller configured to turn off the first switch and turn on the second switch in response to the auxiliary battery being inserted into the battery slot.

According to another exemplary embodiment of the present disclosure provides a computer-implemented method for controlling a battery system of a vehicle. The method comprises determining whether an auxiliary battery is inserted in a battery slot. The method further comprises turning off a first switch that connects a load of the vehicle and a main battery in response to the auxiliary battery being inserted into the battery slot. The method further comprises turning on a second switch that connects the load of the vehicle and the auxiliary battery.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view showing the arrangement of batteries in a vehicle according to various exemplary embodiments of the present disclosure.

FIG. 2 is a view showing the configuration of a battery system connected to a load of a vehicle according to various exemplary embodiments of the present disclosure.

FIG. 3 is a view for explaining charging between batteries according to various exemplary embodiments of the present disclosure.

FIG. 4 is a view showing the configuration of a battery system connected to a load of a vehicle according to various exemplary embodiments of the present disclosure.

FIG. 5 is a view showing the configuration of a battery system connected to a load of a vehicle according to various exemplary embodiments of the present disclosure.

FIG. 6 is a flowchart illustrating a control method of a battery system according to various exemplary embodiments of the present disclosure.

It may be understood that the appended drawings are not necessarily to scale, presenting a somewhat simplified representation of various features illustrative of the basic principles of the invention. The specific design features of the present disclosure as disclosed herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the invention(s) will be described in conjunction with exemplary embodiments of the present disclosure, it will be understood that the present description is not intended to limit the invention(s) to those exemplary embodiments of the present disclosure. On the other hand, the invention(s) is/are intended to cover not only the exemplary embodiments of the present disclosure, but also various alternatives, modifications, equivalents and other embodiments, which may be included within the spirit and scope of the invention as defined by the appended claims.

The embodiments of the present disclosure relates to a battery system of a vehicle using a swappable auxiliary battery, and a control method thereof.

The main object of the embodiments of the present disclosure is directed to providing a battery system of a vehicle for extending the lifespan of a main battery and supplying a large amount of power by preferentially using swappable auxiliary batteries rather than the main battery, and a control method thereof.

An object of an exemplary embodiment of the present disclosure is directed to providing a battery system of a vehicle for preventing parts from being damaged by electric sparks according to a voltage difference between batteries when power of a main battery and power of auxiliary batteries are supplied together, and a control method thereof.

An object of another exemplary embodiment of the present disclosure is directed to providing a battery system of a vehicle for utilizing power of auxiliary batteries to the maximum by transferring power remaining in the auxiliary batteries to the main battery when swappable auxiliary batteries are swapped, and a control method thereof.

The problems to be solved by the present disclosure are not limited to the problems mentioned above, and unmentioned other problems will be clearly understood by those skilled in the art from the description below.

Hereinafter, various exemplary embodiments of the present disclosure are described in detail using exemplary drawings. In adding reference numerals to the components of each drawing, it should be noted that the same components have the same numerals as much as possible although they are shown on different drawings. Furthermore, in describing the present disclosure, when it is determined that a detailed description of a related known configuration or function may obscure the gist of the present disclosure, the detailed description will be omitted.

In describing the components of according to an exemplary embodiment of the present disclosure, symbols such as first, second, i), ii), a), b), and the like may be used. These symbols are only for distinguishing the components from other components, and the nature, sequence, or order of corresponding components is not limited by the symbols. In the specification, when a part is said to ‘include’ or ‘comprise’ a certain component, it means that it may further include other components, rather than excluding other components, unless explicitly stated otherwise.

Each component of the device or method according to an exemplary embodiment of the present disclosure may be implemented as hardware or software, or a combination of hardware and software. Furthermore, the function of each component may be implemented as software, and implemented so that a microprocessor may execute the function of software corresponding to each component.

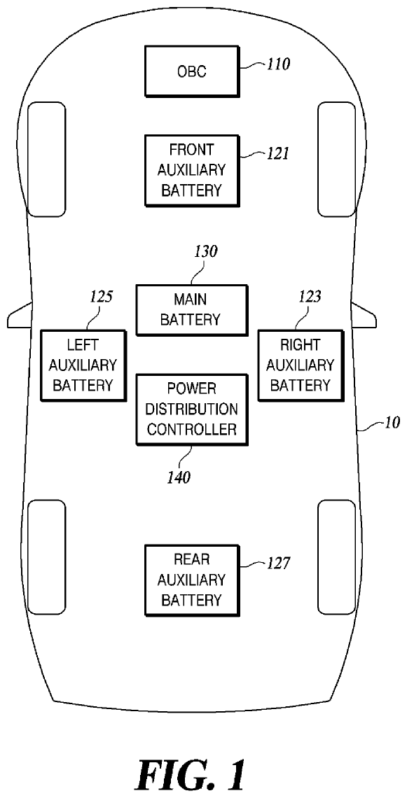

FIG. 1 is a view showing the arrangement of batteries in a vehicle according to various exemplary embodiments of the present disclosure.

Referring to FIG. 1, a vehicle 10 basically includes an On-Board Charger (OBC) 110 and a main battery 130 as a battery system. The OBC 110 is a converter device for charging the main battery 130 from an external power source. The main battery 130 is a high voltage battery and may supply main power to the vehicle 10. The main battery 130 may be fixed to the vehicle 10 and may be located at the center portion of the vehicle 10 considering the center of gravity. The vehicle 10 may be shipped with the main battery 130 installed.

However, when the vehicle 10 includes only the main battery 130, the main battery 130 may include a problem in supplying power needed for the vehicle 10 due to the limitation in capacity and lifespan of the main battery 130.

Therefore, in order to supply power to the vehicle 10 while extending the lifespan of the main battery 130, the vehicle 10 may further include auxiliary batteries 121, 123, 125, and 127 and a power distribution controller (PDC) 140.

Specifically, the vehicle 10 may include battery slots into which the auxiliary batteries 121, 123, 125, and 127 may be inserted, and the PDC 140 for controlling power of the batteries.

The auxiliary batteries 121, 123, 125, and 127 are high voltage batteries swappable in the battery slots of the vehicle 10 and may be inserted into or separated from the battery slots. Furthermore, the auxiliary batteries 121, 123, 125, and 127 may be swapped by a human or a robot. Furthermore, the auxiliary batteries 121, 123, 125, and 127 may be charged by the OBC 110.

The auxiliary batteries 121, 123, 125, and 127 may be provided on the left, right, front, and rear sides of the vehicle for the sake of the center of gravity of the vehicle 10. The auxiliary batteries 121, 123, 125, and 127 may be provided on the bottom of the vehicle 10 for easy swapping.

The PDC 140 is a device for transmitting power from the main battery 130 or the auxiliary batteries 121, 123, 125, and 127 to the motor of the vehicle 10. The PDC 140 may be referred to as a zonal converter integrated controller or a zonal power distribution controller (zonal PDC). The PDC 140 appropriately utilizes power of each battery according to the state of charge or weight of the main battery 130 and the auxiliary batteries 121, 123, 125, and 127. Particularly, the vehicle 10 preferentially utilizes power of the auxiliary batteries 121, 123, 125, and 127 to prevent decrease of lifespan of the main battery 130 caused by charging and discharging.

Furthermore, the PDC 140 may perform functions such as switch control for battery voltage balancing, battery charging control, power stabilization, failure diagnosis, and the like.

In the present manner, the vehicle 10 may be supplied with a large amount of power through swapping of the auxiliary batteries 121, 123, 125, and 127 while protecting the main battery 130 by using the auxiliary batteries 121, 123, 125, and 127.

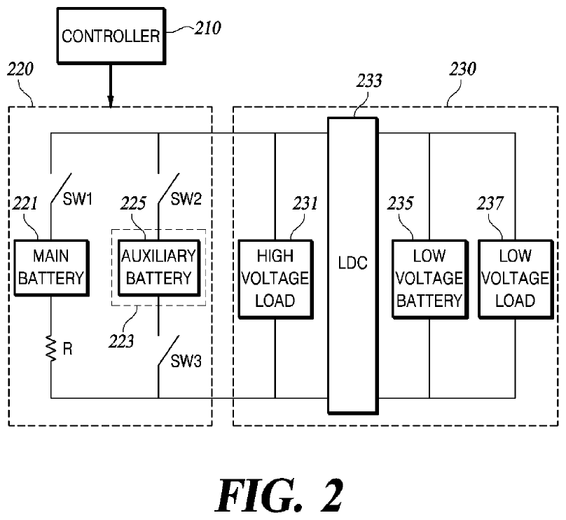

FIG. 2 is a view showing the configuration of a battery system connected to a load of a vehicle according to various exemplary embodiments of the present disclosure.

Referring to FIG. 2, the battery system of a vehicle includes a controller 210 and a power supply unit 220. Here, the controller 210 may represent the PDC 140.

The power supply unit 220 includes a main battery 221, a battery slot 223, and switches, and stores energy to be supplied to the load 230 of the vehicle. Here, the battery slot 223 provides a space into which an auxiliary battery 225 is inserted. The switches may be transistors such as MOSFETs or BJTs.

The load 230 is a component that consumes power of the vehicle, and includes at least one of a high voltage load 231, a low DC/DC converter (LDC) 233, a low voltage battery 235, and a low voltage load 237. The high voltage load 231 represents a device requiring a high input voltage. For example, the high voltage load 231 may be supplied with an input voltage of 174V from the power supply unit 220. Meanwhile, the LDC 233 is a converter that converts the high voltage of the power supply unit 220 into a low voltage and transfers the low voltage to the low voltage battery 235 or the low voltage load 237. For example, the LDC drops a voltage of 174V of the power supply unit 220 to 12V and then applies the 12V voltage to the low voltage battery 235, or drops a voltage of 174V to 60V and then applies the 60V voltage to the low voltage load 237. In addition to this, the load 230 may further include devices that require power of the vehicle.

The controller 210 transfers the energy stored in the main battery 221 or the auxiliary battery 225 to the load 230 by controlling the switches in the power supply unit 220. Particularly, the controller 210 preferentially connects the auxiliary battery 225 to the load 230, rather than the main battery 221. To the present end, the controller 210 may include at least one memory including instructions and at least one processor.

The power supply unit 220 supplies power to the load 230 based on switching control of the controller 210.

Specifically, the main battery 221 in the power supply unit 220 is connected to the load 230 in parallel using a first switch SW1. The first switch SW1 connects the main battery 221 and the load 230. To the present end, one end of the first switch SW1 is connected to the main battery 221, and the other end of the first switch SW1 is connected to the load 230. One end of the main battery 221 is connected to the first switch SW1, and the other end of the main battery 221 is connected to the load 230 through a resistance component R.

The battery slot 223 is connected in parallel to the load 230 using a second switch SW2 and a third switch SW3. The second switch SW2 and the third switch SW3 connect the battery slot 223 to the load 230. To the present end, one end of the second switch SW2 is connected to the other end of the first switch SW1 and the load 230, and the other end of the second switch SW2 is connected to one end of the battery slot 223. Furthermore, the other end of the battery slot 223 is connected to the load 230 using the third switch SW3 and connected to the main battery 221 using the third switch SW3 and the resistance component R. However, in other exemplary embodiments of the present disclosure, the third switch SW3 and the resistance component R may be omitted.

Meanwhile, the controller 210 detects that the auxiliary battery 225 is inserted in the battery slot 223. When the auxiliary battery 225 is not inserted in the battery slot 223, the controller 21 connects the main battery 221 to the load 230 by turning on the first switch SW1 and turning off the second switch SW2 or the third switch SW3.

On the other hand, when the auxiliary battery 225 is inserted in the battery slot 223, the controller 21 connects the auxiliary battery 225, instead of the main battery 221, to the load 23 by turning off the first switch SW1 and turning on the second switch SW2 and the third switch SW3. Since the auxiliary battery 225 is swappable, the controller 210 may protect the main battery 221 by preferentially using the power of the auxiliary battery 225 rather than the power of the main battery 221.

The auxiliary battery 225 connected to the load 230 supplies power to the load 230, instead of the main battery 221.

Meanwhile, the controller 210 compares a power level required by the load 230 with the maximum power level of the auxiliary battery 225. Here, the power level of the auxiliary battery 225 is a value calculated based on the voltage and current of the auxiliary battery 225. For example, since a voltage of 174V should be applied to the load 230, the power level of the auxiliary battery 225 may be calculated based on the voltage of 174V and the current that can be output from the auxiliary battery 225.

For example, when a motor of a vehicle momentarily requires strong torque, the required power level of the load 230 may increase. At the present point, the controller 210 may be configured to determine that the maximum power level of the auxiliary battery 225 is lower than the required power level. As another example, when the driving distance according to the state of charge of the auxiliary battery is shorter than the distance to a preset destination, the controller 210 may be configured to determine that the required power level of the load is higher than the maximum power level of the auxiliary battery. The driving distance according to the state of charge of the auxiliary battery may be calculated by the controller 210 or an external device, and the distance to a preset destination may be calculated by the navigation system of the vehicle.

The controller 210 additionally connects the main battery 221 to the load 230 according to the result of the comparison. Specifically, when the required power level of the load 230 is higher than the maximum power level of the auxiliary battery 225, the controller 210 may turn on the first switch SW1 to supply power to the load 230 using the main battery 221 and the auxiliary battery 225 together. When all of the first switch SW1, the second switch SW2, and the third switch SW3 are turned on, the load 230, the main battery 221, and the auxiliary battery 225 are connected in parallel. As described, the controller 210 may supply necessary power using the energy of the main battery 221 together when the state of charge of the swappable auxiliary battery 225 is insufficient.

Meanwhile, when the first switch SW1 of the main battery 221 is immediately turned on while the auxiliary battery 225 is connected to the load 230, sparks may occur according to a voltage difference.

Therefore, the controller 210 according to various exemplary embodiments of the present disclosure is configured to perform battery voltage balancing by controlling at least one of the second switch SW2 and the third switch SW3 before turning on the first switch SW1.

Specifically, the controller 210 detects and compares voltages of the main battery 221 and the auxiliary battery 225. When the voltage of both ends of the main battery 221 is higher than the voltage of both ends of the auxiliary battery 225, the controller 210 is configured to control the third switch SW3 to generate the voltage of both ends of the third switch SW3. The controller 210 may control the current flowing through the third switch SW3 or the voltage of the third switch SW3 by adjusting the voltage applied to the gate terminal or the base terminal of the third switch SW3 or adjusting the switching duty ratio. For example, in the linear control section of the third switch SW3, voltage is generated by the internal resistance and the current between the source and the drain. The controller 210 may control the third switch SW3 so that the sum of the voltage of the third switch SW3 and the voltage of the auxiliary battery 225 corresponds to the voltage of the main battery 221. Accordingly, the sum of the voltage of the auxiliary battery 225 and the voltage of the third switch SW3 may be equal to the voltage of the main battery 221. That is, the main battery 221 and the auxiliary battery 225 are voltage balanced.

Meanwhile, in another exemplary embodiment of the present disclosure, the controller 210 may perform battery voltage balancing by controlling the second switch SW2, instead of the third switch SW3.

After the battery voltage balancing, the controller 210 may connect both the main battery 221 and the auxiliary battery 225 to the load 230 in parallel without electric sparks by turning on the first switch SW1.

As described above, the controller 210 and the power supply unit 220 preferentially use the auxiliary battery 225 to supply power to the load 230, and may supply power using the main battery 221 together according to the required power level. Furthermore, damage to devices caused by electric sparks may be prevented through the battery voltage balancing before connecting the main battery 221.

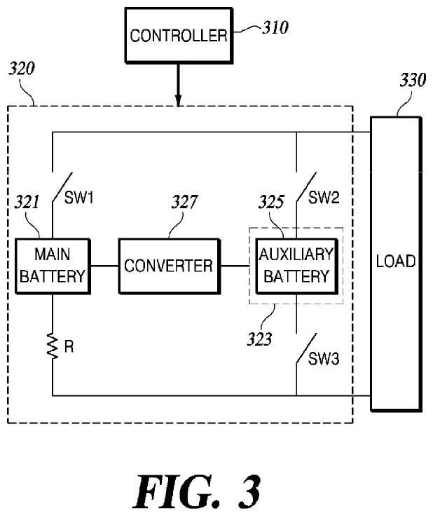

FIG. 3 is a view for explaining charging between batteries according to various exemplary embodiments of the present disclosure.

Referring to FIG. 3, the battery system of a vehicle includes a controller 310 and a power supply unit 320. The power supply unit 320 includes a main battery 321, a battery slot 323, an auxiliary battery 325, a converter 327, and switches, and is connected to a load 330. The load 330 may be the same as the load 230 of FIG. 2. Since the functions of the components of the battery system are the same as those of the components of FIG. 2, detailed description thereof will be omitted.

The auxiliary battery 325 is a swappable battery and may be swapped with another auxiliary battery according to the state of charge of the auxiliary battery 325. At the present point, although a sufficient amount of charge remains in the auxiliary battery 325, the auxiliary battery 325 may be swapped with a new auxiliary battery fully charged. In the present case, the vehicle user may not use all of the energy remaining in the auxiliary battery 325.

Therefore, according to various exemplary embodiments of the present disclosure, the power supply unit 320 charges the main battery 321 from the auxiliary battery 325 using the converter 327 before separating the auxiliary battery 325 from the battery slot 323. Here, the converter 327 includes at least one switch element and a transformer.

Specifically, the controller 310 may receive a separation request signal for the auxiliary battery 325 from an external battery exchange center or a battery swapping system in the vehicle. To the present end, a communication interface such as an antenna may be provided in the controller 310.

The controller 310 may transfer power of the auxiliary battery 325 to the main battery 321 by controlling the switches in the converter 327. Particularly, when the charge amount of the auxiliary battery 325 is greater than the charge amount of the main battery 321, the controller 310 may transfer the charge amount of the auxiliary battery 325 to the main battery 321.

Furthermore, in another exemplary embodiment of the present disclosure, the controller 310 may transfer power of the main battery 321 to the auxiliary battery 325 as needed using the converter 327.

When the charge amount of the main battery 321 is greater than or equal to the charge amount of the auxiliary battery 325, or when the charge amount of the auxiliary battery 325 is exhausted, the controller 310 may transmit a signal informing that the auxiliary battery 325 is in a detachable state to the external battery exchange center portion or the battery swapping system.

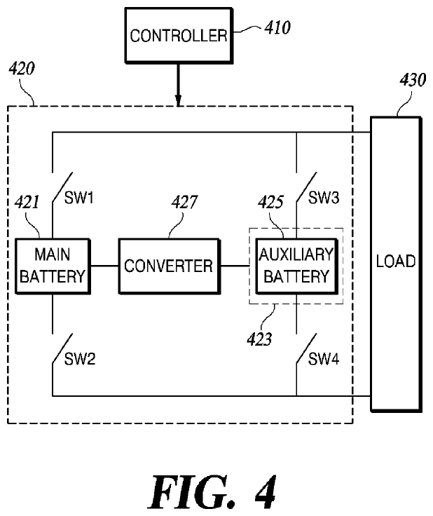

FIG. 4 is a view showing the configuration of a battery system connected to a load of a vehicle according to various exemplary embodiments of the present disclosure.

Referring to FIG. 4, the battery system of a vehicle includes a controller 410 and a power supply unit 420. The power supply unit 420 includes a main battery 421, a battery slot 423, an auxiliary battery 425, a converter 427, and switches, and is connected to a load 430. The load 430 may be the same as the load 230 of FIG. 2. Since the functions of the components are the same as those of the components of FIG. 2, detailed description thereof will be omitted.

However, unlike FIG. 2, in FIG. 4, the switches SW1 and SW2 are connected to both ends of the main battery 421. The main battery 421 is connected to the load 430 in parallel using the first switch SW1 and the second switch SW2, and the battery slot 423 is connected to the load 430 in parallel using the third switch SW3 and the fourth switch SW4.

The first switch SW1 and the second switch SW2 may be used as switches for separating and coupling the main battery 421 and the battery slot 423, respectively. The third switch SW3 and the fourth switch SW4 may be used as switches for battery voltage balancing.

Here, although the controller 410 may perform battery voltage balancing using the third switch SW3 or the fourth switch SW4, it may also perform battery voltage balancing using the second switch SW2.

That is, the controller 410 may control the second switch SW2 so that the sum of the voltage of the main battery 421 and the voltage of the second switch SW2 is equal to the voltage of the auxiliary battery 425. When the second switch SW2 is a MOSFET device, the controller 410 may perform voltage balancing by adjusting the magnitude or duty ratio of the input voltage of the gate terminal of the second switch SW2.

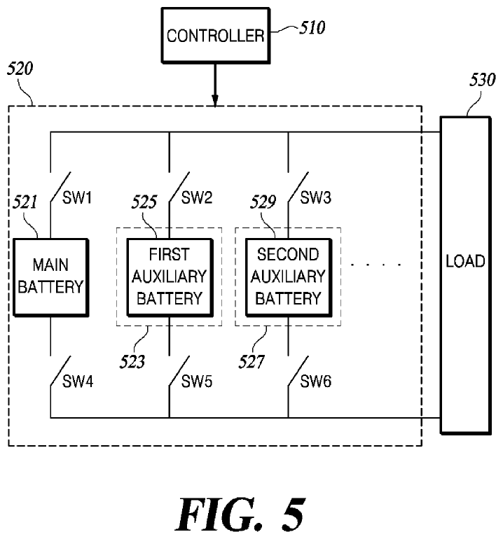

FIG. 5 is a view showing the configuration of a battery system connected to a load of a vehicle according to various exemplary embodiments of the present disclosure.

Referring to FIG. 5, the battery system of a vehicle includes a controller 510 and a power supply unit 520. The power supply unit 520 includes a main battery 521, a first battery slot 523, a first auxiliary battery 525, a second battery slot 527, a second auxiliary battery 529, and switches, and is connected to a load 530. The load 530 may be the same as the load 230 of FIG. 2. Since the functions of the components are the same as those of the components of FIG. 2, detailed description thereof will be omitted.

The battery system of a vehicle may include one or more auxiliary batteries.

The power supply unit 520 may further include the first battery slot 523, the second battery slot 527, and additional battery slots.

The number of battery slots may be determined in consideration of the weight of the vehicle, required amount of power, and the like.

The power supply unit 520 may protect the main battery 521 and supply a large amount of energy by preferentially using a plurality of auxiliary batteries rather than the main battery 521.

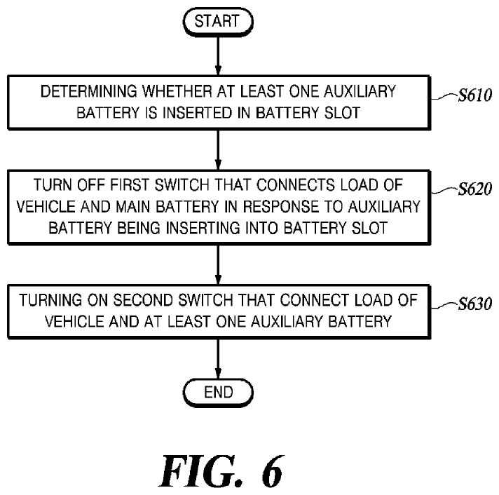

FIG. 6 is a flowchart illustrating a control method of a battery system according to various exemplary embodiments of the present disclosure.

The battery system of a vehicle includes a controller and a power supply unit, and the power supply unit includes a main battery, a battery slot, and switches. The main battery in the power supply unit is connected to the load of the vehicle using a first switch. The battery slot is connected to the load of the vehicle using a second switch. Specifically, a first end of the first switch is connected to the main battery, and a second end of the first switch is connected to a first end of the second switch and the load of the vehicle. The other end of the second switch is connected to one end of the battery slot. A second end of the battery slot is connected to the load of the vehicle and the main battery using a third switch.

The controller detects that the auxiliary battery is inserted in the battery slot (S610).

For example, batteries of the vehicle may be swapped by an operator or a robot at a battery exchange center. After swapping batteries, a swap completion signal is transmitted from the operator or the robot to the vehicle, and when the swap completion signal is received, the controller may determine that the auxiliary battery is inserted.

In response to the auxiliary battery being into the battery slot, the controller turns off the first switch that connects the load of the vehicle and the main battery (S620).

Furthermore, the controller turns on the second switch that connects the load of the vehicle and the auxiliary battery (S630).

That is, when the auxiliary battery is inserted in the battery slot, the controller disconnects the main battery from the load of the vehicle and establishes a connection between the auxiliary battery and the load of the vehicle. The auxiliary battery is connected to the battery slot, and the battery slot is connected to the load of the vehicle through the second switch. Through this, the controller may preferentially supply power of the auxiliary battery to the vehicle rather than the power of the main battery.

Thereafter, the controller may determine whether the required power level of the load of the vehicle is higher than the maximum power level of the auxiliary battery while the vehicle is driving, and may turn on the first switch accordingly.

For example, when the driving distance according to the state of charge of the auxiliary battery is shorter than the distance to a destination of the vehicle, the controller may be configured to determine that the required power level of the load of the vehicle is higher than the maximum power level of the auxiliary battery. In the present case, the controller turns on the first switch.

However, when the first switch is turned on without considering the voltage difference between the main battery and the auxiliary battery, parts may be damaged by electric sparks.

Before turning on the first switch, the controller according to various exemplary embodiments of the present disclosure is configured to perform battery voltage balancing by controlling at least one of the second switch and the third switch. Specifically, the controller is configured to control at least one of the second switch and the third switch so that the sum of the voltage of the at least one of the second switch and the third switch and the voltage of the auxiliary battery corresponds to the voltage of the main battery.

Thereafter, when driving of the vehicle is completed or swapping of the auxiliary battery is required, the controller may receive a signal requesting separation of the auxiliary battery. For example, after the vehicle enters a battery exchange center, the controller may receive a signal requesting separation of the auxiliary battery.

At the present point, the controller charges the main battery using the auxiliary battery in order to fully utilize the remaining power of the auxiliary battery. Specifically, the controller compares the state of charge of the auxiliary battery with the state of charge of the main battery. Based on the result of the comparison, the controller transfers the energy stored in the auxiliary battery to the main battery using a converter connected to the main battery and the battery slot. For example, when the amount of charge of the auxiliary battery is greater than the amount of charge of the main battery, the controller transfers the energy of the auxiliary battery to the main battery using the converter.

As described above, according to various exemplary embodiments of the present disclosure, it is possible to extend the lifespan of a main battery and supply a large amount of power by preferentially using swappable auxiliary batteries rather than the main battery.

According to various exemplary embodiments of the present disclosure, it is possible to prevent parts from being damaged by electric sparks according to a voltage difference between batteries when power of a main battery and power of auxiliary batteries are supplied together.

According to various exemplary embodiments of the present disclosure, it is possible to utilize power of auxiliary batteries to the maximum by transferring power remaining in the auxiliary batteries to the main battery when swappable auxiliary batteries are swapped.

The effects of the present disclosure are not limited to the effects mentioned above, and unmentioned other effects will be clearly understood by those skilled in the art from the description below.

Various implementation examples of the systems and techniques described in the present specification may be realized as a digital electronic circuit, integrated circuit, field programmable gate array (FPGA), application specific integrated circuit (ASIC), computer hardware, firmware, software, and/or a combination thereof. These various implementation examples may include implementations as one or more computer programs that can be executed on a programmable system. The programmable system includes at least one programmable processor (this may be a special purpose processor or a general-purpose processor) coupled to receive data and instructions from a storage system, at least one input device, and at least one output device and transmit data and instructions to them. The computer programs (also known as programs, software, software applications, or codes) include instructions for the programmable processor and are stored in a “computer readable recording medium”.

The computer-readable recording medium includes all types of recording devices in which data that can be read by a computer system is stored. The computer-readable recording medium may be a non-volatile or non-transitory medium such as ROM, CD-ROM, a magnetic tape, a floppy disk, a memory card, a hard disk, a magneto-optical disk, a storage device, or the like, and in addition, it may further include transitory media such as a data transmission medium. Furthermore, the computer-readable recording media may be distributed in computer systems connected through a network, and computer-readable codes may be stored and executed in a distributed manner.

Although it is described in the flowchart or the timing diagram of the present specification that the steps are sequentially executed, this is merely describing the technical spirit of an exemplary embodiment of the present disclosure as an example. In other words, since those skilled in the art may apply by variously changing and modifying to execute the steps by changing the order described in the flowchart or the timing diagram or execute one or more steps among the steps in parallel without departing from the essential characteristics of an exemplary embodiment of the present disclosure, the flowchart or the timing chart is not limited to a time-series sequence.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may be configured to generate a control signal according to the processing result.

The control device may be at least one microprocessor operated by a predetermined program which may include a series of commands for carrying out the method disclosed in the aforementioned various exemplary embodiments of the present disclosure.

The aforementioned invention can also be embodied as computer readable codes on a computer readable recording medium. The computer readable recording medium is any data storage device that can store data which can be thereafter read by a computer system and store and execute program instructions which can be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by multiple control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. disclosed in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the invention to the precise forms disclosed, and obviously many modifications and variations are possible in light of the above teachings. The exemplary embodiments were chosen and described in order to explain predetermined principles of the invention and their practical application, to enable others skilled in the art to make and utilize various exemplary embodiments of the present disclosure, as well as various alternatives and modifications thereof. It is intended that the scope of the invention be defined by the Claims appended hereto and their equivalents.

What is claimed is:

1. A battery system of a vehicle, the battery system comprising:
a main battery configured to be selectively connected to a load of the vehicle using a first switch;
a battery slot providing a space into which at least one auxiliary battery is inserted and connected to the load of the vehicle using a second switch; and
a controller configured to turn off the first switch and turn on the second switch in response to the at least one auxiliary battery being inserted into a corresponding battery slot.

2. The battery system of claim 1,
wherein a first end of the first switch is connected to the main battery,
wherein a second end of the first switch is connected to a first end of the second switch and the load of the vehicle,
wherein a second end of the second switch is connected to a first end of the battery slot, and
wherein a second end of the battery slot is connected to the load of the vehicle and the main battery using a third switch.

3. The battery system of claim 2, wherein a resistance component is connected between the main battery and the third switch.

4. The battery system of claim 2, wherein the controller is further configured to turn on the first switch in response that a required power level of the load of the vehicle is higher than a maximum power level of the auxiliary battery.

5. The battery system of claim 4, wherein the controller is further configured to perform battery voltage balancing by controlling at least one of the second switch and the third switch before turning on the first switch.

6. The battery system of claim 5, wherein the controller is further configured to control the at least one of the second switch and the third switch so that a sum of a voltage of the at least one of the second switch and the third switch and a voltage of the at least one auxiliary battery corresponds to a voltage of the main battery.

7. The battery system of claim 4, wherein in response that a driving distance of the vehicle according to a state of charge of the at least one auxiliary battery is shorter than a distance to a destination of the vehicle, the controller is further configured to determine that the required power level of the load of the vehicle is higher than the maximum power level of the auxiliary battery.

8. The battery system of claim 1, further including a converter configured to transfer energy stored in the at least one auxiliary battery to the main battery based on the control of the controller.

9. The battery system of claim 8, wherein the controller is further configured to:
compare a state of charge of the at least one auxiliary battery and a state of charge of the main battery in response to receiving a separation request signal for the at least one auxiliary battery; and
control the converter according to a result of the comparison.

10. The battery system of claim 9, wherein in response that an amount of the charge of the at least one auxiliary battery is greater than an amount of the charge of the main battery, the controller is configured to transfer the energy of the at least one auxiliary battery to the main battery using the converter.

11. A computer-implemented method for controlling a battery system of a vehicle, the method comprising:
determining, by a controller, whether at least one auxiliary battery is inserted in a battery slot;
turning off, by the controller, a first switch that connects a load of the vehicle and a main battery, in response to the at least one auxiliary battery being inserted into the battery slot; and
turning on, by the controller, a second switch that connects the load of the vehicle and the at least one auxiliary battery.

12. The method of claim 11,
wherein a first end of the first switch is connected to the main battery,
wherein a second end of the first switch is connected to a first end of the second switch and the load of the vehicle,
wherein a second end of the second switch is connected to a first end of the battery slot, and
wherein a second end of the battery slot is connected to the load of the vehicle and the main battery using a third switch.

13. The method of claim 12, wherein a resistance component is connected between the main battery and the third switch.

14. The method of claim 12, further including:
turning on, by the controller, the first switch in response that a required power level of the load of the vehicle is higher than a maximum power level of the at least one auxiliary battery.

15. The method of claim 14, further including:
performing, by the controller, battery voltage balancing by controlling at least one of the second switch and the third switch before turning on the first switch.

16. The method of claim 15, wherein the performing battery voltage balancing includes controlling the at least one of the second switch and the third switch so that a sum of a voltage of the at least one of the second switch and the third switch and a voltage of the at least one auxiliary battery corresponds to a voltage of the main battery.

17. The method of claim 14, wherein the turning on the first switch includes determining that in response that a driving distance of the vehicle according to a state of charge of the at least one auxiliary battery is shorter than a distance to a destination of the vehicle, the required power level of the load of the vehicle is higher than the maximum power level of the at least one auxiliary battery.

18. The method of claim 12, further including:
receiving, by the controller, a separation request signal for the at least one auxiliary battery;
comparing, by the controller, a state of charge of the at least one auxiliary battery and a state of charge of the main battery; and
transferring, by the controller, energy stored in the at least one auxiliary battery to the main battery based on a result of the comparison using a converter connected to the main battery and the battery slot.

19. The method of claim 18, wherein in response that an amount of the charge of the at least one auxiliary battery is greater than an amount of the charge of the main battery, the controller is configured to transfer the energy of the at least one auxiliary battery to the main battery using the converter.
